(19) United States
(12) Patent Application Publication
(10) Pub. No.: US 2026/0311130 A1
(43) Pub. Date: Oct. 8, 2026

(54) SYSTEMS AND METHODS FOR PREDICTING PRODUCT SENSORY SHELF-LIFE PROGRESSION USING MACHINE-LEARNING

(71) Applicant: Mars, Incorporated, McLean, VA (US)

(72) Inventors: Jared SHAW, McLean, VA (US); David W. STEFANY, McLean, VA (US); Bruno CHAUVET, McLean, VA (US); Corneel den RIDDER, McLean, VA (US)

(21) Appl. No.: 19/482,989

(22) PCT Filed: May 10, 2024
(86) PCT No.: PCT/US2024/028875

§ 371 Date: Nov. 10, 2025

Related U.S. Application Data
(60) Provisional application No. 63/466,090, filed on May 12, 2023.
(60) Provisional application No. 63/466,122, filed on May 12, 2023.
(60) Provisional application No. 63/466,107, filed on May 12, 2023.

(51) Int. Cl. G06Q 10/087

(52) U.S. Cl. CPC G06Q 10/08776

(57) ABSTRACT

Systems and methods for predicting sensory shelf life progression are provided. The method may include receiving data associated with a product. The data may include one or more sensory attributes of the product. The method may further include providing the one or more sensory attributes of the product to a predictive machine-learning model trained to identify associations between the one or more sensory attributes of the product and output a sensory shelf life progression for the product. The method may further include transmitting the sensory shelf life progression to a display of a user device.

### CROSS-REFERENCE TO RELATED APPLICATION(S)

This application claims the benefit of priority to U.S. Provisional Application No. 63/466,090 filed May 12, 2023, U.S. Provisional Application No. 63/466,122 filed May 12, 2023, and U.S. Provisional Application No. 63/466,107 filed May 12, 2023, all of which are hereby incorporated herein by reference.

### TECHNICAL FIELD

Various embodiments of the present disclosure relate generally to machine-learning based techniques for predicting sensory panel results and, more particularly, to systems and methods for predicting sensory shelf life progression using machine-learning based regression models to approximate sensory attributes of a product. In some embodiments, the disclosure relates to systems and methods for training a machine-learning based model to predict sensory shelf life progression.

### BACKGROUND

The current process for evaluating food products (e.g., confectionery products) involves sensory testing through the full shelf life of a product. In some cases, a full study can take up to 52 weeks before a decision can be made to select a product for launch. In many cases, products may be evaluated using a minimum of three points in time (e.g., at 4 weeks, 12 weeks and 20 weeks) to determine if a product formulation will continue to be evaluated for launch. Further, materials (e.g., finished products, ingredients, packaging) may be placed in environmental chambers to determine respective shelf life by gathering sample data at specific points in time (e.g, a predetermined time) to confirm the material is meeting specific lab measurements to confirm how long the material may be shelf stable. Specifically, food products and packaging may be tested for shelf life by placing them within an environmental chamber using ambient conditions (e.g., a constant temperature and humidity). Depending upon the material is being tested, it may remain in the chamber for up to 52 weeks. Samples may be gathered at predetermined intervals until sufficient data has been collected to confirm the material will not meet required constraints for shelf life or until the testing has reached an end of the time frame to confirm conformance of the material. The time needed to run the testing may have an impact on the speed of innovation (e.g., creation of new or improved products) and on the speed of bringing products to market.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to aspects of the present disclosure, systems and computer-implemented methods are disclosed for predicting a sensory shelf life progression of a product. The systems and methods for predicting a sensory shelf life progression may utilize a machine-learning model. In particular, the machine-learning model may approximate sensory attributes of the product.

In one aspect, a computer-implemented method for predicting sensory shelf life progression may include receiving data associated with a product. The data may include one or more sensory attributes of the product. The method may further include providing the one or more sensory attributes of the product to a predictive machine-learning model trained to identify associations between the one or more sensory attributes of the product and output a sensory shelf life progression for the product. The method may further include transmitting the sensory shelf life progression to a display of a user device.

In another aspect, a system for predicting sensory shelf life progression may include a memory storing instructions and a processor configured to execute the instructions to perform operations. The operations may include receiving data associated with a product. The data may include one or more sensory attributes of the product. The operations may further include providing the one or more sensory attributes of the product to a predictive machine-learning model trained to identify associations between the one or more sensory attributes of the product and output a sensory shelf life progression for the product. The operations may further include transmitting the sensory shelf life progression to a display of a user device.

In another aspect, a non-transitory machine-readable medium storing instructions that, when executed by one or more processors, cause a computing system to perform a method for predicting sensory shelf life progression. The method may include receiving data associated with a product. The data may include one or more sensory attributes of the product. The method may further include providing the one or more sensory attributes of the product to a predictive machine-learning model trained to identify associations between the one or more sensory attributes of the product and output a sensory shelf life progression for the product. The method may further include transmitting the sensory shelf life progression to a display of a user device.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment that may be utilized with techniques presented herein, according to one or more embodiments.

FIG. 2 depicts an exemplary distribution of attributes of a product as assessed by a sensory panel.

FIG. 3 depicts an exemplary graph illustrating predicted profile average responses at 12 weeks from data gathered at 4 weeks compared to actual average responses at 12 weeks.

FIG. 4 depicts an exemplary data flow diagram for testing the shelf life of a product using machine-learning.

FIG. 5A depicts exemplary testing conditions for testing the shelf life of a product.

FIG. 5B depicts an exemplary graph illustrating ambient testing of shelf life compared to accelerated testing of shelf life.

FIG. 6 depicts an exemplary data flow diagram for generating a recipe and a set of tailored manufacturing requirements using machine-learning.

FIG. 7 depicts an exemplary processing environment for formulating a recipe and manufacturing requirements.

FIG. 8 depicts a flowchart illustrating an exemplary method for predicting sensory shelf life progression.

FIG. 9 depicts a flowchart illustrating an exemplary method for generating a recipe and a set of tailored manufacturing requirements using machine-learning.

FIG. 10 depicts an exemplary computer system that may execute techniques presented herein.

### DETAILED DESCRIPTION

Various embodiments of the present disclosure relate generally to machine-learning based techniques for predicting sensory shelf life progression of a product (e.g., of a food product, confectionary product, material, packaging, or the like). More particularly, various embodiments of the present disclosure relate to systems and methods for predicting sensory shelf life progression using machine-learning based regression models to approximate sensory attributes of the product.

Sensory attributes of a food product (e.g., a chocolate confectionary), such as adhesive, caramel essence, chocolate essence and roast peanut, may influence the shelf life of the food product. Accordingly, being able to readily determine a progression of such attributes is critical to product development and testing. Existing methods for assessing or measuring sensory shelf life progression may require data to be gathered a various time intervals over a lengthy period of time.

Therefore, to shorten the time needed to evaluate products and make determinations during such evaluation, one or more machine-learning models may be used to estimate the future sensory panel results of a product. In such implementations, the one or more machine-learning models may predict the sensory shelf life progression using data gathered from a first sensory evaluation (e.g., at 4 weeks).

The embodiments of the present disclosure are directed to solving, mitigating, or rectifying the above-mentioned issues by determining machine-learning models that are configured to predict sensory shelf life progression. The machine-learning models may use an initial set of data gathered at an initial point in time. The systems and methods of the present disclosure may be used to predict sensory shelf life progression, with specific regard to attributes of a food product, such as adhesive, caramel essence, chocolate essence, and roast peanut. In examples, other such attributes associated with a food product may include chocolate essence, dark roast, alkali, vanilla, caramel essence, fruity complex, citrus, winey, woody, nutty, cinnamon, sweet, sour, salt, bitter, astringent, burn, snap, fracturable, moist, cohesive, adhesive, rough, speed of melt, roast peanut, dairy complex, cooked milk, developed milk, nonfat dried milk, butter, elastic, contrast of chew, noise, contrast of bite, roast almond, fruity, brown spice, dense, cooked grain and toasted grain.

Additionally, attributes associated with other edible confections, such as gum, may include hardness, overall flavor, toughness, overall flavor, sweet, bitter, peppermint, menthol, creamy, oral cooling, overall burn, juicy, smoothness, stickiness, bounciness, squeakiness, spearmint, thymol, peppery spicy, vanilla, nasal cooling, oral burn, throat burn, tongue burn, astringent and elastic.

Further, attributes associated with food products, materials, packaging, and the like, may include moisture, water activity, preservatives, surface microorganisms, pH, chemical migration (e.g., from packaging to a food product), texture properties, protein or lipidic oxidation markers (e.g., ketones, peroxide value, aldehydes, fatty acids, and the like), vitamins loss, flavors and aromas, sensory evaluation (e.g., sight, taste, feel), and the like.

In various implementations, the machine-learning models of the present disclosure may include regression models. In various implementations, any suitable regression model may be utilized, including but not limited to, linear, stepwise linear, partial least squares, principal components, support vector (SVR), neural networks, multivariate adaptive, multivariate linear, random forest, polynomial, generalized additive, Bayesian additive regression trees (BART), classification and regression tree (CART), or neural network models such as multi-layer perception (MLP), and recurrent neural networks (RNN), convolutional neural networks (CNN). Based on the prediction, a user may determine if a product is suitable based upon its predicted shelf life.

Although the models and embodiments described herein are directed to food products and materials, the models of the present disclosure are applicable to a variety of products that may be subject to degradation over time (e.g., pharmaceuticals, biological material, chemicals, or the like).

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In the detailed description herein, references to “embodiment,” “an embodiment,” “one non-limiting embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In general, terminology can be understood at least in part from usage in context. For example, terms, such as “and”, “or”, or “and/or,” as used herein can include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, can be used to describe any feature, structure, or characteristic in a singular sense or can be used to describe combinations of features, structures or characteristics in a plural sense. Similarly, terms, such as “a,” “an,” or “the,” again, can be understood to convey a singular usage or to convey a plural usage, depending at least in part upon context. In addition, the term “based on” can be understood as not necessarily intended to convey an exclusive set of factors and can, instead, allow for existence of additional factors not necessarily expressly described, again, depending at least in part on context.

As used herein, the terms “comprises,” “comprising,” or any other variation thereof are intended to cover a non-exclusive inclusion, such that a process, method, composition, article, or apparatus that comprises a list of elements does not include only those elements, but may include other elements not expressly listed or inherent to such process, method, composition, article, or apparatus. The term “exemplary” is used in the sense of “example” rather than “ideal.” As used herein, the singular forms “a,” “an,” and “the” include plural reference unless the context dictates otherwise. Relative terms such as “about,” “substantially,” and “approximately” refer to being nearly the same as a referenced number or value, and should be understood to encompass a variation of ±5% of a specified amount or value.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), deep learning, a deep neural network, etc. Supervised and/or unsupervised training may be employed. For example, supervised learning may include providing training data and labels corresponding to the training data, e.g., as ground truth. Unsupervised approaches may include clustering, classification or the like. Any suitable type of training may be used, e.g., stochastic, gradient boosted, random seeded, recursive, epoch or batch-based, etc.

Certain non-limiting embodiments are described below with reference to block diagrams and operational illustrations of methods, processes, devices, and apparatus. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

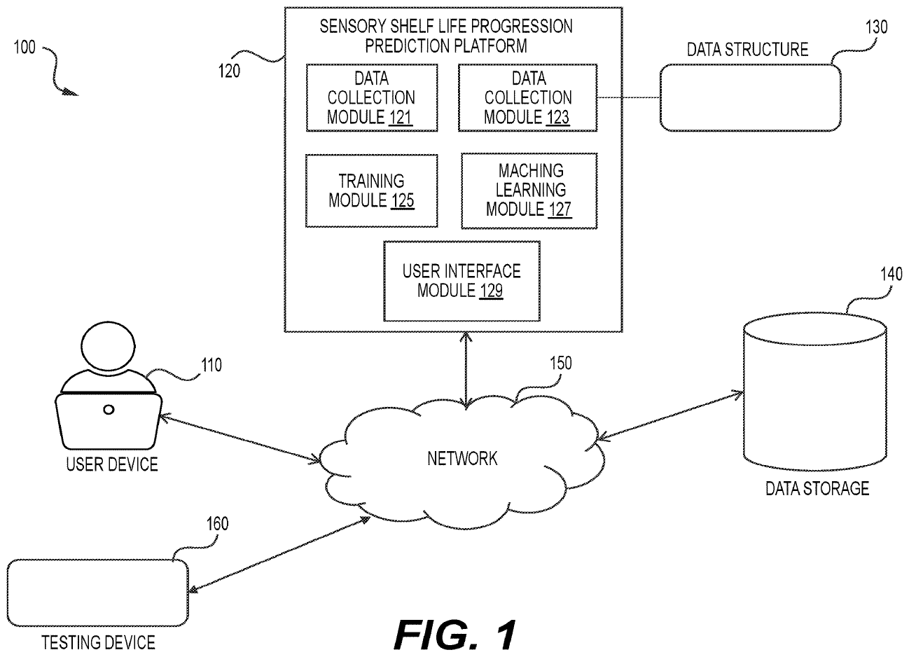

Referring now to the appended drawings, FIG. 1 depicts an exemplary environment 100 that may be utilized with techniques presented herein. A user device 110, a sensory shelf life progression prediction platform 120, and a data storage 140 may communicate across a network 150. The user device 110 may be associated with a user, e.g., a user associated with one or more of generating, training, tuning or using a machine-learning model for predicting a sensory shelf life progression. A user may use the user device 110 to interact with the user interface module 129 of the sensory shelf life progression prediction platform 120.

The sensory shelf life progression prediction platform 120 may be a platform with multiple interconnected components. Sensory shelf life progression prediction platform 120 may include one or more servers, intelligent networking devices, computing devices, components, and corresponding software for determining sensory attributes, analyzing relationships, determining machine-learning models configured to predict sensory shelf life progressions, and making sensory shelf life predictions using trained machine-learning models. The sensory shelf life progression prediction platform 120 comprises data collection module 121, data processing module 123, training module 125, machine-learning model 127, and user interface module 129.

The data collection module 121 may receive an input from user device 110. In some examples, the input may include data associated with a product. In examples, the product may be a food product, such as chocolate or gum. In other examples, the product may be a material, such as packaging and the like. The data associated with the product may include analytical data obtained from analytical testing of the product as well as sensory attributes of the product, such as adhesive, caramel essence, chocolate essence, roast peanut, moisture, water content, or the like. In certain examples, a user may have the option to enter, via a user device 110, data associated with a product for which a sensory shelf life progression is desired to be predicted and the data collection module 121 may receive the input. Additionally or alternatively, the data collection module 121 may receive (e.g., retrieve) the data associated with the product from the data storage 140. In further embodiments, the data collection module 121 may receive the data associated with the product from a testing device 160 (e.g., testing chamber).

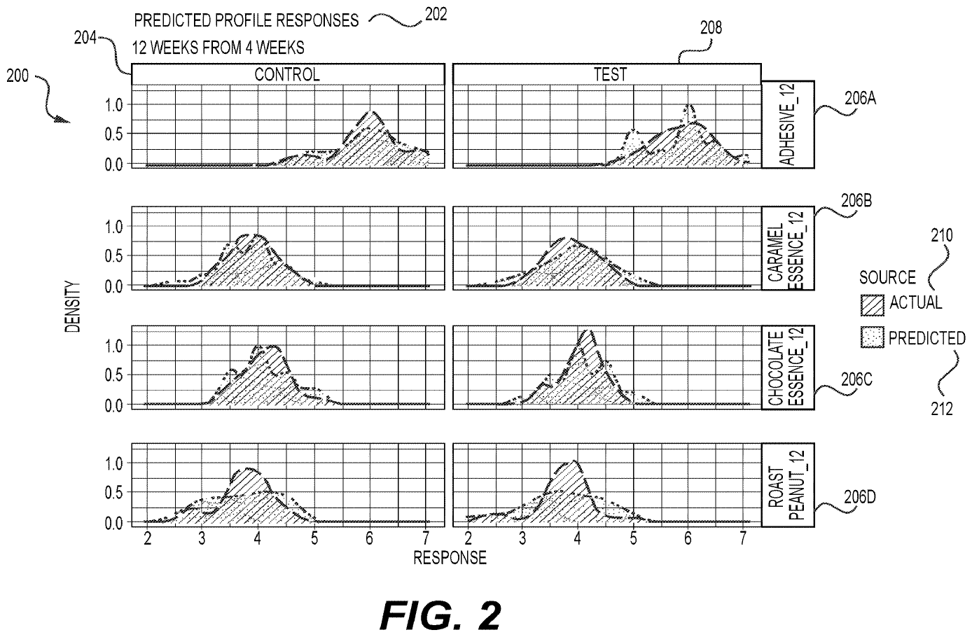

Data processing module 123 may process data collected by data collection module 121. Processing the data collected may include determining an average of the sensory attributes, including actual and predicted shelf life progressions. In examples, the actual shelf life progressions may be input into a machine-learning model to train the machine-learning model to predict a shelf life progression for a product. In some examples, the data processing module 123 may access data that is associated with a product from a database or another information source (e.g., data storage 140). Further details regarding computation of a predicted profile response are provided below in reference to FIG. 2.

In some embodiments, the data processing module 123 generates a data structure 130. Data structure 130 may include each sensory attribute of a product. In at least one example, data structure 130 may be a table.

Training module 125 may provide learning, or training to machine-learning model 127 by providing training data, e.g., data from other modules that contains input (e.g., features) and correct output (e.g., labels), to allow machine-learning model 127 to learn over time. For example, training module 125 may receive data from data structure 130 generated by the data processing module 123. The training may be performed based on the deviation of a processed result from a documented result when the inputs are fed into machine-learning model 127, e.g., an algorithm measures its accuracy through the loss function, adjusting until the error has been sufficiently minimized. Training module 125 may conduct the training in any suitable manner, e.g., in batches, and may include any suitable training methodology. Training may be performed periodically, and/or continuously, e.g., in real-time or near real-time. Further details of training a machine-learning model are provided below.

Machine-learning model 127 may receive the training data from training module 125 to learn relationships between sensory attributes and shelf life progression. The ordering of the training data may be randomized during training.

Machine-learning model 127 may visualize the training data to identify relevant relationships between different variables and identify any data imbalances. The training data may be split into two parts where one part is for training the model and the other part is for validating the trained model, de-duplicating, normalizing, correcting errors in the training data, and so on. In some examples, machine-learning model 127 may receive data directly from data structure 130. Machine-learning model 127 may implement various machine-learning techniques (e.g., random forest, k-nearest neighbor, partial least squares regression, principal component regression, etc.) discussed in the present disclosure.

User interface module 129 may enable a presentation of a graphical user interface (GUI) in user device 110. User interface module 129 may comprise a variety of interfaces, for example, interfaces for data input and output devices, referred to as I/O devices, storage devices, and the like.

Data storage 140 may store and manage data associated with a product. Data storage 140 may store the data structure 130 generated by the data processing module 123. Data storage 140 may also store any information provided by a user via user device 110 an/or testing device 160. In addition, data storage 140 may store data structure 130 generated by the sensory shelf life progression prediction platform 120. In some examples, data storage 140 may include a machine-learning based training database with pre-defined mapping defining a relationship between various input parameters and output parameters based on various statistical methods. The training database may include machine-learning algorithms to learn mappings between sensory attributes and shelf life progression. In some examples herein, the training database is routinely updated and/or supplemented based on machine-learning methods.

FIG. 2 depicts a distribution of the attributes 200 of a food product (e.g., chocolate confection) as assessed by a sensory panel. As illustrated, the distribution of the actual sensory profile versus the predicted sensory profile is compared at a time of 12 weeks. A set of predicted profile responses 202 from 12 weeks to 4 weeks is illustrated. A set of control results 204 show the sensory shelf life progression of a product based upon four sensory attributes, adhesive 206a, caramel essence 206b, chocolate essence 206c and roast peanut 206d. A set of test results 208 also show the sensory shelf life progression of a product based upon the four sensory attributes. As illustrated, the actual sensory shelf life progression 210 is compared with the predicted sensory shelf life progression 212. In various implementations, the actual sensory shelf life progression 210 is determined by measuring the sensory attributes 206a-d at various intervals of time (e.g., 2, 4, 6, 12 weeks or the like). By contrast, the present system and methods enables the predicted sensory shelf life progression 212 to be determined by measuring sensory attributes at only one initial time (e.g., 2, 4, 6 weeks or the like).

A machine-learning model, such as one utilized by machine-learning module 127 as depicted in FIG. 1, may relate the sensory attributes 206a-d to a sensory shelf life progression. For example, the machine-learning model may be trained to determine a correlation between sensory attributes and sensory shelf life progression. Once determined, the machine-learning model 208 may be used to predict a sensory shelf life progression for a product for which the sensory attributes of the product have not been measured more than once, at an initial stage.

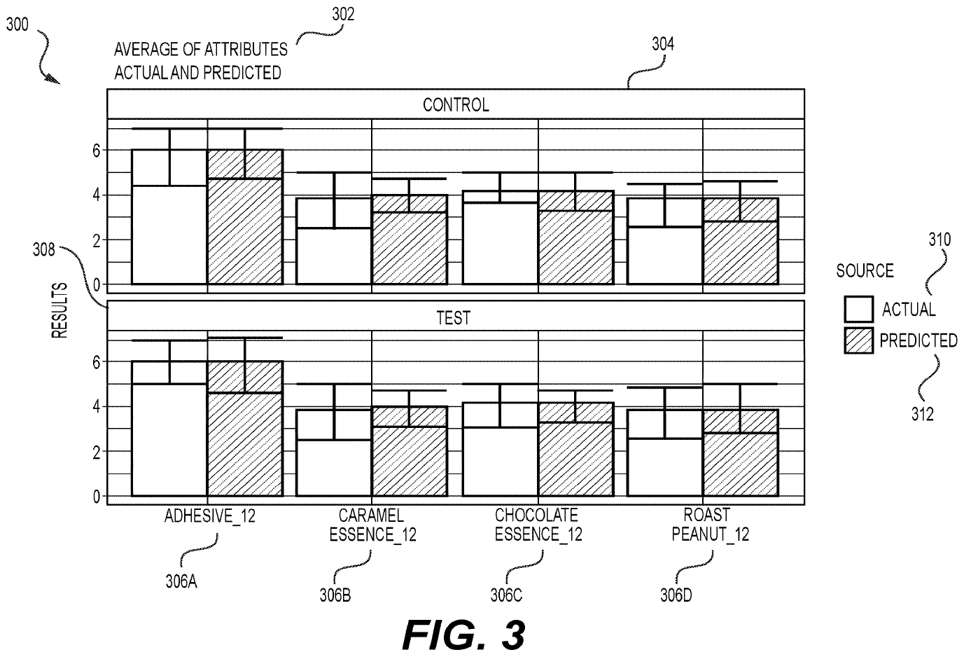

FIG. 3 depicts a graph 300 illustrating predicted profile average responses at 12 weeks from data gathered at 4 weeks compared to the actual average responses at 12 weeks. A set of averages of the attributes 302 is illustrated. A set of control results 304 show the sensory shelf life progression of a product based upon four sensory attributes, adhesive 306a, caramel essence 306b, chocolate essence 306c and roast peanut 306d. A set of test results 308 also show the sensory shelf life progression of a product based upon the four sensory attributes. As illustrated, the actual sensory shelf life progression 310 is compared with the predicted sensory shelf life progression 312. In various implementations, the actual sensory shelf life progression 310 is determined by measuring the sensory attributes 306 a-d at various intervals of time (e.g., 2, 4, 6, 12 weeks or the like). By contrast, the present system and methods enables the predicted sensory shelf life progression 312 to be determined by measuring sensory attributes at only one initial time (e.g., 2, 4, 6 weeks or the like).

A machine-learning model, such as one utilized by machine-learning module 127 as depicted in FIG. 1, may relate the sensory attributes 306a-d to a sensory shelf life progression. For example, the machine-learning model may be trained to determine a correlation between sensory attributes and sensory shelf life progression. Once determined, the machine-learning model 308 may be used to predict a sensory shelf life progression for a product for which the sensory attributes of the product have not been measured more than once at an initial stage.

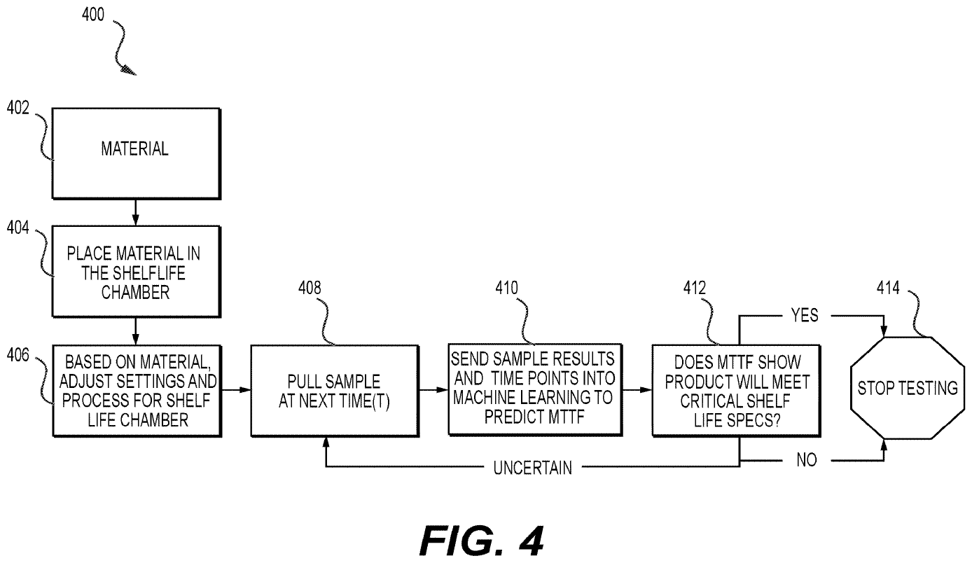

FIG. 4 depicts an exemplary data flow diagram for testing the shelf life of a product using machine-learning. As illustrated, a material 402 (e.g., a product) may be placed in a shelf life testing chamber 404. The settings of the shelf life testing chamber 404 may be adjusted 406 based on the material 402. A sample of the material 402 may be extracted 408 from the shelf life testing chamber at a predetermined time. The sample results and predetermined points in time may be provided to a machine-learning model to predict 410 mean time to failure (MTTF). In examples, MTTF may be used to measure the average time before a coating fails and packaged contents are exposed. Factors like coating thickness, environmental conditions, and manufacturing defects can impact the MTTF of packaging materials. A predicted MTTF may be analyzed to determine if the material 402 will meet a threshold of critical shelf life specifications 412. If the determination meets a level of certainty, testing may cease 414. If the determination does not meets the level of certainty, testing may continue with extracting another sample of the material 402 at another predetermined point in time.

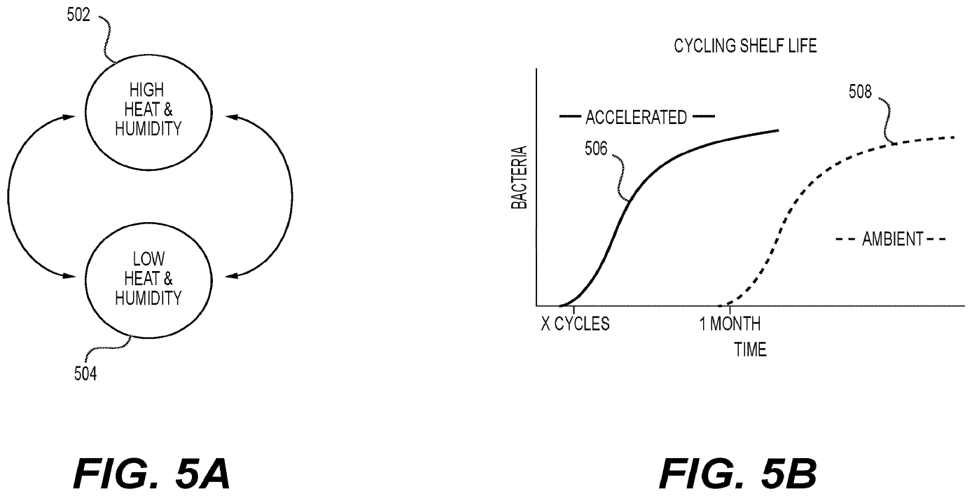

FIG. 5A depicts exemplary testing conditions for testing the shelf life of a product. In various implementations, accelerating shelf life conditions typically requires higher heat and humidity to affect the product. Therefore, setting the shelf life testing chamber to these conditions will speed up degradation, but may not decrease shelf life. By cycling shelf life conditions in the shelf life testing chamber from high heat and high humidity 502 through to low heat and low humidity 504 (e.g., ambient to accelerated), the degradation curve that represents the product may shorten as one adjustment cycle may equal one predetermined point of time, as shown in FIG. 5B.

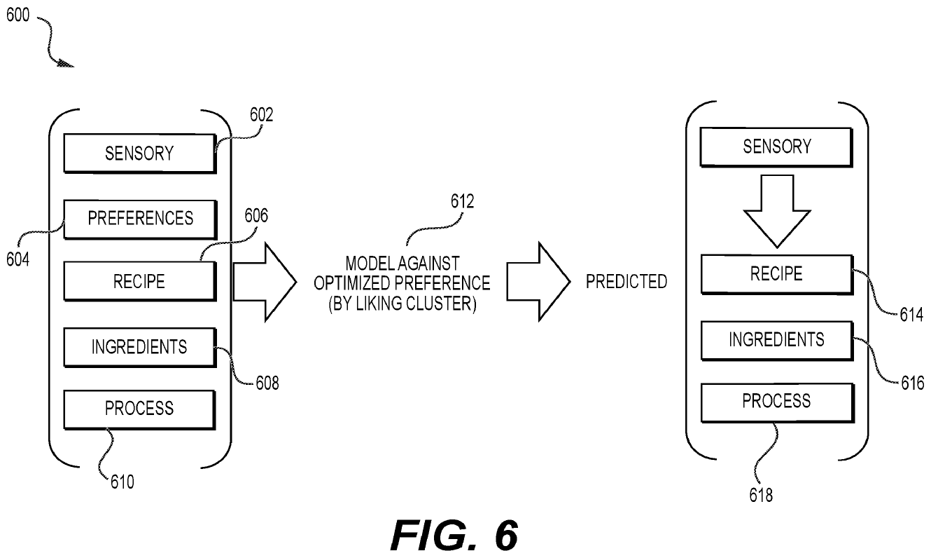

FIG. 6 depicts an exemplary data flow diagram for generating a recipe and a set of tailored manufacturing requirements using machine-learning. As illustrated, data associated with a product, such as sensory attributes 602, consumer preferences 604, existing recipe(s) 606, existing ingredients 608 and existing manufacturing process/requirements 610, may be gathered and input into one or more machine-learning models 612. The one or more machine-learning models 612 may then determine and output a formulated recipe 614, formulated ingredients 616 and a formulated process 618. In examples, the formulated recipe and manufacturing requirements (e.g., formulated process 618) are predicted to meet consumer preferences.

A machine learning model, such as one utilized by machine learning module 127 as depicted in FIG. 1, may relate the data associated with the product to one or more machine learning models. For example, the machine learning model may be trained to determine a correlation between sensory attributes 602 and consumer preferences 604. Once determined, the machine learning model 612 may be used to formulate a recipe and manufacturing requirements for a predicted (e.g., new) product.

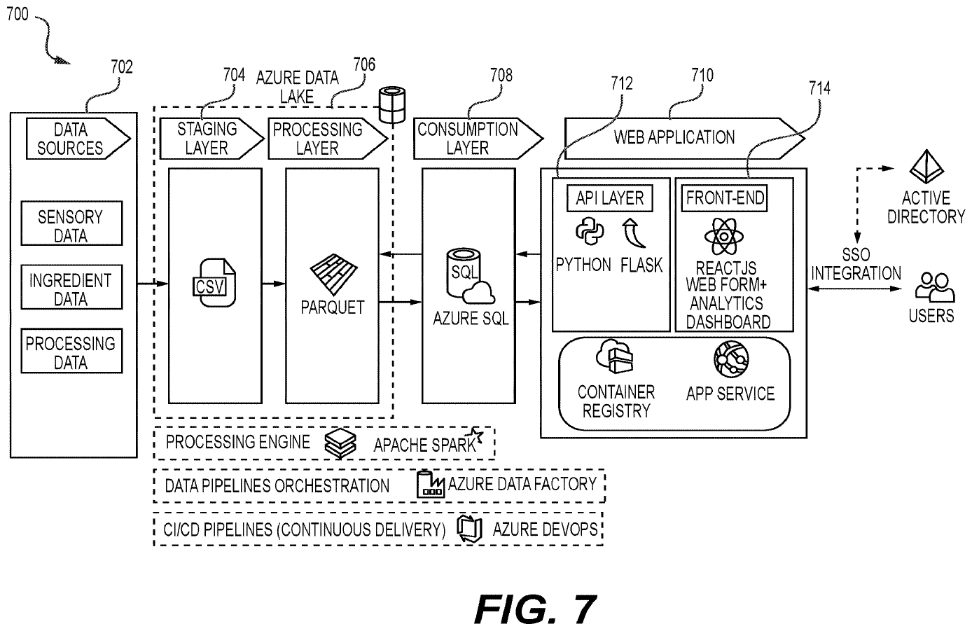

FIG. 7 depicts an exemplary processing environment for formulating a recipe and manufacturing requirements. As illustrated, data (e.g., sensory data, ingredient data, processing/manufacturing data) may be received from a number of data sources 702. The data may be aggregated in a staging layer 704 and processed in a processing layer 706. A consumption layer 708 may serve as intermediary between the processing layer 706 and a web application 710. The web application 710 may include an application programming interface (API) layer 712 and a front-end 714 (e.g., a user interface). In various implementations, processing environment 700 may be implemented in one or more modules depicted in FIG. 1, such as data processing module 123 and/or user interface module 129.

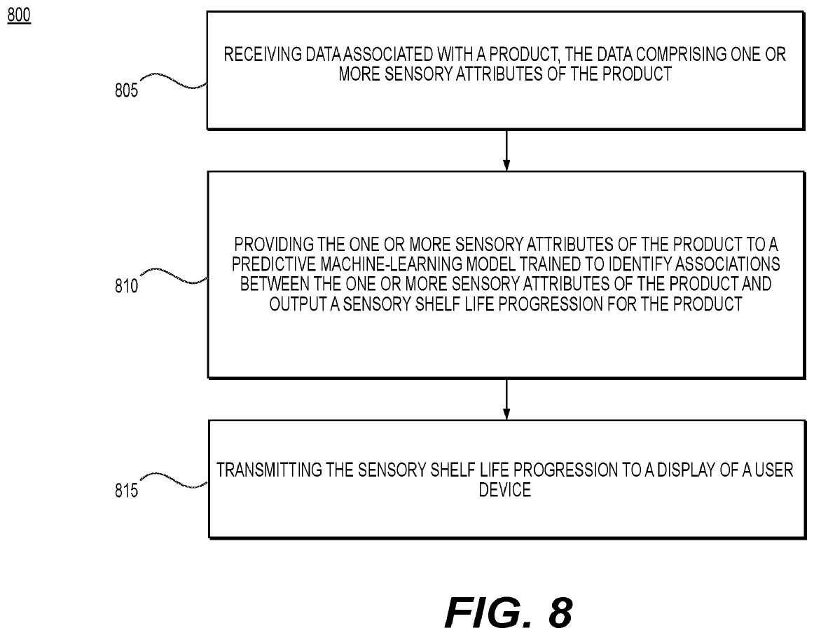

FIG. 8 depicts a flowchart illustrating an exemplary method 800 of predicting sensory shelf life progression according to the present disclosure. Method 800 may be performed by the sensory shelf life progression prediction platform 120 of FIG. 1. In particular, the machine-learning model may be used to predict a sensory shelf life progression of a product.

In step 805, data associated with a product may be received. In examples, the product may be a food product, such as a chocolate confection or other food product. The data may include one or more sensory attributes. In examples, the one or more sensory attributes may include one or more of adhesive, caramel essence, chocolate essence and roast peanut. As described in the present system and methods, the data associated with the product may be gathered at a single, specific point in time (e.g., 2, 4, 6 weeks or the like). In some examples, a user may input data associated with a product to the user interface module 129 of the sensory shelf life progression prediction platform 120 via the user device 110. In other examples, the data associated with a product may be retrieved from the data storage 140. The data may identify sensory attributes of the product. The data may be received by data collection module 121.

In step 810, the data associated with the product may be provided to a machine-learning model. In step 815, a trained machine-learning model may be used to determine a sensory shelf life progression for the product based on the sensory attributes received in step 805. The trained machine-learning model used in step 810 (e.g., machine-learning model 127) may be trained in any suitable manner. The trained machine-learning model may use one or more regression model to determine the sensory shelf life progression. In examples, such regression models may include linear, stepwise linear, partial least squares, principal components, support vector (SVR), neural networks, multivariate adaptive, multivariate linear, random forest, polynomial, generalized additive, Bayesian additive regression trees (BART), classification and regression tree (CART), or neural network models such as multi-layer perception (MLP), and recurrent neural networks (RNN), convolutional neural networks (CNN). In various implementations, the prediction for the sensory shelf life progression may be displayed on a graphical user interface (GUI) of a user device, such as user device 110 depicted in FIG. 1. At step 815, the sensory shelf life progression may be transmitted to a display of a user device.

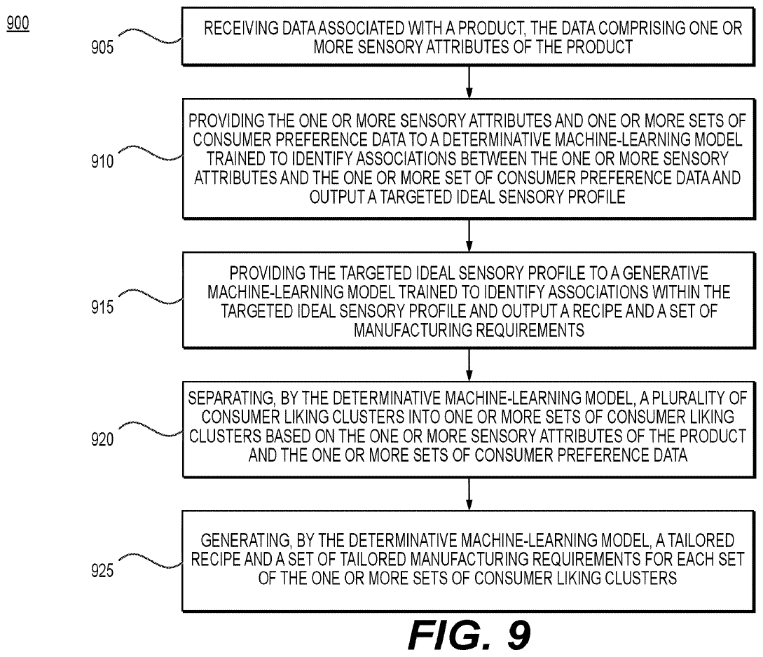

FIG. 9 depicts a flowchart illustrating an exemplary method for generating a recipe and a set of tailored manufacturing requirements using machine-learning. Method 900 may be performed by the sensory shelf life progression prediction platform 120 of FIG. 1. In particular, the machine-learning model may be used to generate a tailored recipe and a set of tailored manufacturing requirements for each set of the one or more sets of consumer liking clusters.

In step 905, data associated with a product may be received. In examples, the product may be a food product, such as a chocolate confection or other food product. The data may include one or more sensory attributes and consumer preferences. In examples, the one or more sensory attributes may include one or more of touch, smell, taste and the like. In some examples, a user may input data associated with a product to the user interface module 129 of the product formulation platform 120 via the user device 110. In other examples, the data associated with a product may be retrieved from the data storage 140. The data may identify sensory attributes and consumer preferences of the product. The data may be received by data collection module 121.

At step 910, the one or more sensory attributes and one or more sets of consumer preference data may be provided to a determinative machine-learning model trained to identify associations between the one or more sensory attributes and the one or more set of consumer preference data and output a targeted ideal sensory profile. At step 915, the targeted ideal sensory profile may be provided to a generative machine-learning model trained to identify associations within the targeted ideal sensory profile and output a recipe and a set of manufacturing requirements. In examples, the recipe may include a precise listing of ingredients to manufacture the edible confection. In other examples, the manufacturing requirements may include a precise listing of ordered steps for manufacture and processing conditions to manufacture the edible confection.

At step 920, the determinative machine-learning model may separate a plurality of consumer liking clusters into one or more sets of consumer liking clusters based on the one or more sensory attributes of the product and the one or more sets of consumer preference data. At step 925, the determinative machine-learning model may generate a tailored recipe and a set of tailored manufacturing requirements for each set of the one or more sets of consumer liking clusters.

The trained machine-learning models used in steps 910, 915, and 920 (e.g., machine-learning model 127) may be trained in any suitable manner. The trained machine-learning model may use one or more regression model to ultimately formulate the recipe and manufacturing requirements. In examples, such regression models may include linear, stepwise linear, partial least squares, principal components, support vector (SVR), neural networks, multivariate adaptive, multivariate linear, random forest, polynomial, generalized additive, Bayesian additive regression trees (BART), classification and regression tree (CART), or neural network models such as multi-layer perception (MLP), and recurrent neural networks (RNN), convolutional neural networks (CNN). In various implementations, the formulated recipe and manufacturing requirements may be displayed on a graphical user interface (GUI) of a user device, such as user device 110 depicted in FIG. 1.

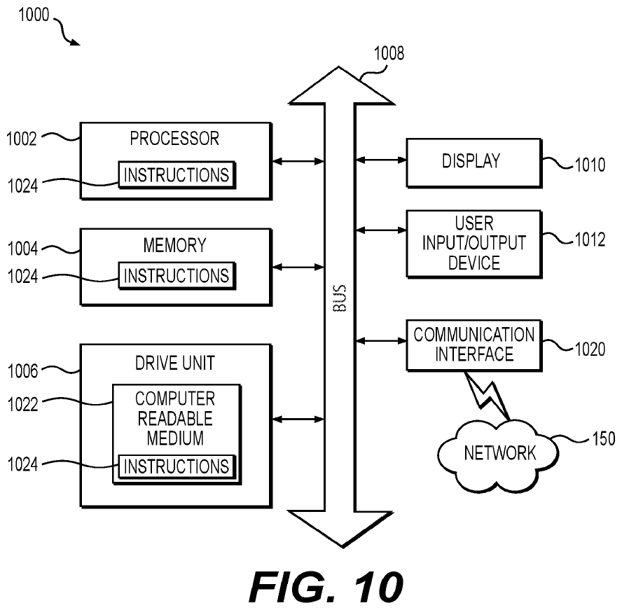

FIG. 10 illustrates an implementation of a computer system that may execute techniques presented herein. The computer system 1000 can include a set of instructions that can be executed to cause the computer system 1000 to perform any one or more of the methods or computer based functions disclosed herein. The computer system 1000 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 1000 may operate in the capacity of a server or as a client user computer in a server-client user network environment, or as a peer computer system in a peer-to-peer (or distributed) network environment. The computer system 1000 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 1000 can be implemented using electronic devices that provide voice, video, or data communication. Further, while a single computer system 1000 is illustrated, the term “system” shall also be taken to include any collection of systems or sub-systems that individually or jointly execute a set, or multiple sets, of instructions to perform one or more computer functions.

As illustrated in FIG. 10, the computer system 1000 may include a processor 1002, e.g., a central processing unit (CPU), a graphics processing unit (GPU), or both. The processor 1002 may be a component in a variety of systems.

For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data. The processor 1002 may implement a software program, such as code generated manually (i.e., programmed).

The computer system 1000 may include a memory 1004 that can communicate via a bus 1008. The memory 1004 may be a main memory, a static memory, or a dynamic memory. The memory 1004 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 1004 includes a cache or random-access memory for the processor 1002. In alternative implementations, the memory 1004 is separate from the processor 1002, such as a cache memory of a processor, the system memory, or other memory. The memory 1004 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1004 is operable to store instructions executable by the processor 1002. The functions, acts or tasks illustrated in the figures or described herein may be performed by the programmed processor 1002 executing the instructions stored in the memory 1004. The functions, acts or tasks are independent of the particular type of instructions set, storage media, processor or processing strategy and may be performed by software, hardware, integrated circuits, firm-ware, micro-code and the like, operating alone or in combination.

Likewise, processing strategies may include multiprocessing, multitasking, parallel processing and the like.

As shown, the computer system 1000 may further include a display unit 1010, such as a liquid crystal display (LCD), an organic light emitting diode (OLED), a flat panel display, a solid-state display, a cathode ray tube (CRT), a projector, a printer or other now known or later developed display device for outputting determined information. The display 1010 may act as an interface for the user to see the functioning of the processor 1002, or specifically as an interface with the software stored in the memory 1004 or in the drive unit 1006.

Additionally or alternatively, the computer system 1000 may include an input device 1012 configured to allow a user to interact with any of the components of system 1000. The input device 1012 may be a number pad, a keyboard, or a cursor control device, such as a mouse, or a joystick, touch screen display, remote control, or any other device operative to interact with the computer system 1000.

The computer system 1000 may also or alternatively include a disk or optical drive unit 1006. The disk drive unit 1006 may include a computer-readable medium 1022 in which one or more sets of instructions 1024, e.g., software, can be embedded. Further, the instructions 1024 may embody one or more of the methods or logic as described herein. The instructions 1024 may reside completely or partially within the memory 1004 and/or within the processor 1002 during execution by the computer system 1000. The memory 1004 and the processor 1002 also may include computer-readable media as discussed above.

In some systems, a computer-readable medium 1022 includes instructions 1024 or receives and executes instructions 1024 responsive to a propagated signal so that a device connected to network 150 (e.g., as depicted in FIG. 1) can communicate voice, video, audio, images, or any other data over the network 150. Further, the instructions 1024 may be transmitted or received over the network 150 via a communication port or interface 1020, and/or using a bus 1008. The communication port or interface 1020 may be a part of the processor 1002 or may be a separate component. The communication port 1020 may be created in software or may be a physical connection in hardware. The communication port 1020 may be configured to connect with a network 150, external media, the display 1010, or any other components in system 1000, or combinations thereof. The connection with the network 150 may be a physical connection, such as a wired Ethernet connection or may be established wirelessly as discussed below. Likewise, the additional connections with other components of the system 1000 may be physical connections or may be established wirelessly. The network 150 may alternatively be directly connected to the bus 1008.

While the computer-readable medium 1022 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 1022 may be non-transitory, and may be tangible.

The computer-readable medium 1022 can include a solid-state memory such as a memory card or other package that houses one or more non-volatile read-only memories. The computer-readable medium 1022 can be a random-access memory or other volatile re-writable memory. Additionally or alternatively, the computer-readable medium 1022 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 1000 may be connected to one or more networks 150 (e.g., as depicted in FIG. 1). The network 150 may define one or more networks including wired or wireless networks. The wireless network may be a cellular telephone network, an 802.11, 802.16, 802.20, or WiMax network. Further, such networks may include a public network, such as the Internet, a private network, such as an intranet, or combinations thereof, and may utilize a variety of networking protocols now available or later developed including, but not limited to TCP/IP based networking protocols. The network 150 may include wide area networks (WAN), such as the Internet, local area networks (LAN), campus area networks, metropolitan area networks, a direct connection such as through a Universal Serial Bus (USB) port, or any other networks that may allow for data communication. The network 150 may be configured to couple one computing device to another computing device to enable communication of data between the devices. The network 150 may generally be enabled to employ any form of machine-readable media for communicating information from one device to another. The network 150 may include communication methods by which information may travel between computing devices. The network 150 may be divided into sub-networks. The sub-networks may allow access to all of the other components connected thereto or the sub-networks may restrict access between the components. The network 150 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for predicting sensory shelf life progression, the method comprising:
receiving, by one or more processors, data associated with a product, the data comprising one or more sensory attributes of the product;
providing, by the one or more processors, the one or more sensory attributes of the product to a predictive machine-learning model trained to identify associations between the one or more sensory attributes of the product and output a sensory shelf life progression for the product;
transmitting, by the one or more processors, the sensory shelf life progression to a display of a user device.

2. The computer-implemented method of claim 1, wherein the data associated with the product is gathered at a predetermined point in time.

3. The computer-implemented method of claim 2, wherein the predetermined point in time is four weeks.

4. The computer-implemented method of claim 1, wherein the one or more sensory attributes comprise one or more of adhesive, caramel essence, chocolate essence, moisture, oxidation, vitamin loss, surface microoganisms, touch, smell, and taste.

5. The computer-implemented method of claim 1, wherein the product is an edible product.

6. The computer-implemented method of claim 1, further comprising:
providing, by the one or more processors, the one or more sensory attributes and one or more sets of consumer preference data to a determinative machine-learning model trained to identify associations between the one or more sensory attributes and the one or more set of consumer preference data and output a targeted ideal sensory profile; and
transmitting, by the one or more processors, the targeted ideal sensory profile to the display of the user device.

7. The computer-implemented method of claim 6, further comprising:
providing, by the one or more processors, the targeted ideal sensory profile to a generative machine-learning model trained to identify associations within the targeted ideal sensory profile and output a recipe and a set of manufacturing requirements; and
transmitting, by the one or more processors, the recipe and the set of manufacturing requirements to the display of the user device.

8. The computer-implemented method of claim 7, further comprising:
separating, by the determinative machine-learning model, a plurality of consumer liking clusters into one or more sets of consumer liking clusters based on the one or more sensory attributes of the product and the one or more sets of consumer preference data; and
generating, by the determinative machine-learning model, a tailored recipe and a set of tailored manufacturing requirements for each set of the one or more sets of consumer liking clusters.

9. A system for predicting sensory shelf life progression, the system comprising:
a memory storing instructions; and
a processor configured to execute the instructions to perform operations comprising:
receiving, by the processor, data associated with a product, the data comprising one or more sensory attributes of the product;
providing, by the processor, the one or more sensory attributes of the product to a predictive machine-learning model trained to identify associations between the one or more sensory attributes of the product and output a sensory shelf life progression for the product;
transmitting, by the processor, the sensory shelf life progression to a display of a user device.

10. The system of claim 9, wherein the data associated with the product is gathered at a predetermined point in time.

11. The system of claim 10, wherein the predetermined point in time is four weeks.

12. The system of claim 9, wherein the one or more sensory attributes comprise one or more of adhesive, caramel essence, chocolate essence, moisture, oxidation, vitamin loss, surface microoganisms, touch, smell, and taste.

13. The system of claim 9, wherein the product is an edible product.

14. The system of claim 9, the operations further comprising:
providing, by the processor, the one or more sensory attributes and one or more sets of consumer preference data to a determinative machine-learning model trained to identify associations between the one or more sensory attributes and the one or more set of consumer preference data and output a targeted ideal sensory profile; and
transmitting, by the processor, the targeted ideal sensory profile to the display of the user device.

15. The system of claim 14, the operations further comprising:
providing, by the processor, the targeted ideal sensory profile to a generative machine-learning model trained to identify associations within the targeted ideal sensory profile and output a recipe and a set of manufacturing requirements; and
transmitting, by the processor, the recipe and the set of manufacturing requirements to the display of the user device.

16. The system of claim 15, the operations further comprising:
separating, by the determinative machine-learning model, a plurality of consumer liking clusters into one or more sets of consumer liking clusters based on the one or more sensory attributes of the product and the one or more sets of consumer preference data; and
generating, by the determinative machine-learning model, a tailored recipe and a set of tailored manufacturing requirements for each set of the one or more sets of consumer liking clusters.

17. A non-transitory machine-readable medium storing instructions that, when executed by one or more processors, cause a computing system to perform a method for predicting sensory shelf life progression, the method comprising:
receiving, by one or more processors, data associated with a product, the data comprising one or more sensory attributes of the product;
providing, by the one or more processors, the one or more sensory attributes of the product to a predictive machine-learning model trained to identify associations between the one or more sensory attributes of the product and output a sensory shelf life progression for the product;
transmitting, by the one or more processors, the sensory shelf life progression to a display of a user device.

18. The non-transitory machine-readable medium of claim 17, the method further comprising:
providing, by the one or more processors, the one or more sensory attributes and one or more sets of consumer preference data to a determinative machine-learning model trained to identify associations between the one or more sensory attributes and the one or more set of consumer preference data and output a targeted ideal sensory profile; and
transmitting, by the one or more processors, the targeted ideal sensory profile to the display of the user device.

19. The non-transitory machine-readable medium of claim 18, the method further comprising:
providing, by the one or more processors, the targeted ideal sensory profile to a generative machine-learning model trained to identify associations within the targeted ideal sensory profile and output a recipe and a set of manufacturing requirements; and
transmitting, by the one or more processors, the recipe and the set of manufacturing requirements to the display of the user device.

20. The non-transitory machine-readable medium of claim 19, the method further comprising:
separating, by the determinative machine-learning model, a plurality of consumer liking clusters into one or more sets of consumer liking clusters based on the one or more sensory attributes of the product and the one or more sets of consumer preference data; and
generating, by the determinative machine-learning model, a tailored recipe and a set of tailored manufacturing requirements for each set of the one or more sets of consumer liking clusters.
